(19) United States
(12) Patent Application Publication
(10) Pub. No.: US 2002/0100649 A1
(43) Pub. Date: Aug. 1, 2002

(54) Vehicle suspension damper with integral linear position sensor

(75) Inventors: Demetris A. Agrotis, El Paso, TX (US); Bradley S. Farrenkopf, Campinas (BR); Kari A. Roth, London, OH (US); George A. Spaeth, Mason, OH (US)

Correspondence Address: DELPHI TECHNOLOGIES, INC., P.O. BOX 5052, 1450 W. Long Lake, Mail Code: 482-204-450, Troy, MI, 48098, US

(73) Assignee: DELPHI AUTOMOTIVE SYSTEMS

(21) Appl. No.: 09/774,135

(22) Filed: Jan. 30, 2001

(51) Int. Cl. F16F 9/00

(52) U.S. Cl. 188/266.1; 188/284

(57) ABSTRACT

A vehicle suspension damper configured to be arranged between a wheel assembly and a body of a vehicle is provided that includes a cylindrical reservoir tube with a piston mounted for reciprocating movement within the reservoir tube. A piston rod is connected to the piston and extending axially therefrom and through one end of the reservoir tube. An annular rod guide assembly surrounds the piston rod and includes a magnetic portion. A non-magnetic dust tube is disposed around the reservoir tube, the dust tube being operatively connected to the piston rod. A generally longitudinal sensor housing is formed in the dust tube adjacent the magnetic portion and a linear sensor is disposed in the sensor housing adapted to detect the position of the magnetic portion.

### TECHNICAL FIELD

The technical field of this disclosure is vehicle suspension dampers for use in active vehicle suspension systems. Such systems include struts, shocks or damper devices capable of varying the damping characteristics, preload and other characteristics of the vehicle suspension in response to position and velocity information of the damper device. An integral linear position sensor located on the damper device generates the position and velocity information.

### BACKGROUND OF THE INVENTION

Current vehicle suspensions frequently incorporate shock or strut devices capable of varying their damping characteristics in response to input from a control system. This input is typically generated by a control system in response to one or more suspension related input signals. One important input signal indicates the velocity of movement between the vehicle sprung mass, i.e., the main body of the vehicle, and the vehicle unsprung mass, i.e., the wheel assembly. This input signal is used in controlling the performance of the damper.

Another important relationship of a vehicle to driving surfaces is the vehicle ride height. When a vehicle weight changes, as when an additional load is added to the vehicle, the vehicle suspension is compressed and the vehicle ride height changes accordingly. If the position of the vehicle body can be sensed relative to the wheel assembly, the ride height of the vehicle can be corrected by various methods. For example, compressed air can be introduced or vented from one or more of the damper units to adjust the vehicle ride height.

The prior art includes sensors that sense the relative position between the sprung and unsprung masses (body and wheel assembly) of a vehicle. One example discloses a standalone non-integral-to-damper sensor positioned in the wheel well of a vehicle or body of a vehicle and having a link attaching the body mounted sensor to the unsprung mass. The sensor measures wheel to body motion as well as compliance, due to rubber bushings incorporated in the suspension. Due to the bushings and normal manufacturing tolerances, and non-linear mounting linkage ratios, the sensor also measures motion that is not related directly to the damper motion. Over time, due to normal wear, the tolerances can increase and the rubber can deteriorate such that accuracy the accuracy of the sensor is reduced. Control algorithms must necessarily be complicated to account for these extraneous motions and wear. Further, the location of the sensor in the wheel well makes it vulnerable to damage in harsh driving conditions.

The prior art includes publications describing systems in which the vehicle suspension at a wheel includes a suspension relative position sensor such as a Linear Variable Differential Transformer (LVDT). The position signal from such a sensor may be differentiated to provide a relative velocity signal. The prior art also includes relative velocity sensors incorporated in suspension components such as dampers. For example, one such system discloses a sensor incorporated in a vehicle shock absorber of the type having a cylinder attached to one of the sprung and unsprung masses and a piston in the cylinder attached through a rod extending out of the cylinder to the other of the sprung and unsprung masses. The rod further carries a dust tube that extends over a substantial portion of the cylinder. An axially polarized annular magnet is attached to but magnetically spaced from the top of the cylinder and is further magnetically spaced from the piston rod; and a sensor winding is distributed axially along the inside of the dust tube, which is made of a non-magnetic material. Vertical motion between the sprung and unsprung masses causes similar axial motion between the dust tube and cylinder and moves the magnet axially along the sensor winding. A variation of flux linkage with respect to the position of the magnet generates an output voltage. The voltage generated is used to calculate the relative position of the unit and over time, can be used to calculate velocity information. Electrical components extending into the rod control the magnetic flux in the damper to effect changes in a MR fluid and thus, effects damping characteristics of the damper unit.

However, these systems typically require extremely small air gaps, which limits design options, and can affect the accuracy of the information generated if not properly maintained. In addition, the coils, made of a very fine wire, are easily damaged if an attempt is made to mold them into a plastic element of a damper such as a dust tube. The coils can be damaged due to thermal stress, contact with a harsh environment or misalignment of the damper and so on.

It would be advantageous to provide a robust, high resolution, fast response time linear position sensor to generate detailed position and velocity information for a vehicle control system.

### SUMMARY OF THE INVENTION

One aspect of the present invention provides a vehicle suspension damper configured to be arranged between a wheel assembly and a body of a vehicle including a cylindrical reservoir tube with a piston mounted for reciprocating movement within the reservoir tube. A piston rod is connected to the piston and extends axially therefrom and through one end of the reservoir tube. An annular rod guide assembly surrounds the piston rod and includes a magnetic portion. A non-magnetic dust tube is disposed around the reservoir tube, the dust tube being operatively connected to the piston rod. A generally longitudinal sensor housing is formed in the dust tube adjacent the magnetic portion and a linear sensor is disposed in the sensor housing adapted to detect the position of the magnetic portion.

In other aspects of the present invention the sensor housing can include a electronics housing portion and a waveguide housing portion extending from the electronics housing portion. The linear sensor can include a waveguide portion disposed in the waveguide housing portion. The linear sensor can include an associated electronics portion operatively connected to the waveguide portion, the electronics portion disposed in the electronics housing portion. The linear sensor can include a magneto-restrictive sensor. The dust tube can be formed of a plastic material. The sensor can include a magnetostrictive waveguide portion. The waveguide portion can be spaced apart from the magnetic portion a distance less than about 13 millimeters. The sensor can be adapted to determine a relative velocity between the vehicle wheel assembly and body.

Another aspect of the present invention provides a dust tube for a vehicle damper including a non-magnetic cylindrical portion having an annular, disc-shaped upper end. A sensor housing is formed in the cylindrical portion, the sensor housing including an electronics housing portion and a waveguide housing portion.

In other aspects of the present invention the electronics housing portion can be formed adjacent the upper end of the cylindrical portion. The waveguide housing can extend from the electronics housing portion toward a lower end of the cylindrical portion. The dust tube can be made of a non-magnetic material such as a plastic material. The dust tube can further include a linear sensor disposed in the sensor housing adapted to detect the position of the magnetic portion. The linear sensor can include a waveguide portion operatively connected to an electronic portion. The waveguide portion can be disposed in the waveguide housing portion and the electronic portion can be disposed in the electronic housing portion. The linear sensor can be a magneto-restrictive sensor. The linear sensor can include a magnetostrictive waveguide portion.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a side view of one embodiment of the damper of the present invention.

FIG. 2 is a cross-sectional view of FIG. 1 along lines 2-2.

FIG. 3 is a side view of the dust tube of the damper of FIG. 1.

FIG. 4 is a cross-sectional view of FIG. 3 along lines 4-4.

FIG. 5 is a perspective view of a portion of the damper of and embodiment of the present invention showing a terminal portion of the sensor.

FIG. 6 is a perspective view of a top portion of the damper of an embodiment of the present invention.

FIG. 7 is a perspective view of an embodiment of the sensor of the present invention.

FIG. 8 is an alternate perspective view of the sensor of FIG. 7.

### DETAILED DESCRIPTION OF THE PRESENTLY PREFERRED EMBODIMENTS

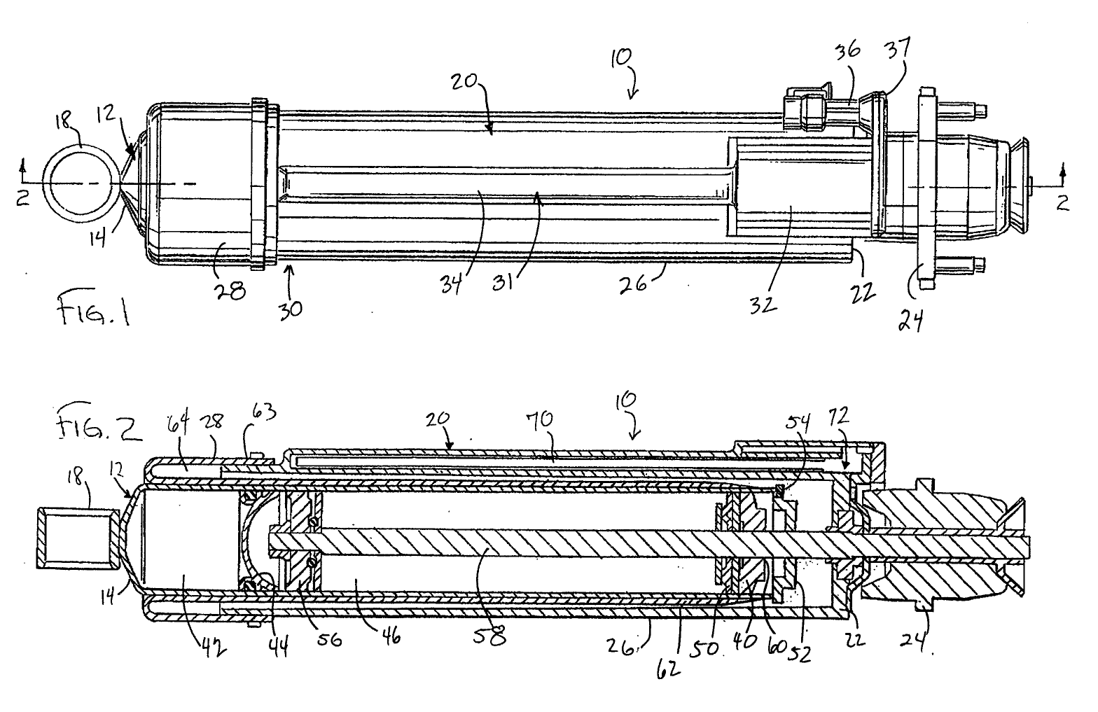

Referring to FIG. 1, one embodiment of a vehicle damper of the present invention is shown in a side view generally at 10. Shock absorber or monotube damper 10 includes a reservoir tube 12, a lower end of which is shown at 14. The lower end 14 of reservoir tube 12 includes a standard fitting 18 for connection to an associated vehicle wheel assembly (not shown).

The damper 10 includes a dust tube 20 with a radial disc portion 22 adjacent an upper fitting 24. The dust tube 20 includes a cylindrical sidewall portion 26 that extends from disc portion 22. The reservoir tube 12 movably fits within cylindrical sidewall portion 26 of dust tube 20. A rubber bag 28 is connected to the bottom 30 of the sidewall 26 and connects to the reservoir tube 12 in a manner that will be described more fully hereinafter. Along the outside of cylindrical sidewall 26 and extending axially from a position adjacent the periphery of the disc portion 22 to a point adjacent the rubber bag 28 a hollow longitudinal sensor housing 31 is provided. The sensor housing 31 includes a wide, generally rectangular electronic housing portion 32, which narrows to a narrow, waveguide housing portion 34. Laterally displaced from the rectangular electronic housing portion 32 is an extending terminal housing portion 36. A sensor housing cap 37, which connects to sensor housing portions 32 and 36, permits insertion and inspection of the internal sensor parts and associated circuitry.

With reference to FIG. 2, a cross-sectional view of the damper of FIG. 1, is shown generally at 10. Shock absorber 10 includes a reservoir tube 12 having an upper rod guide 40 and is closed at the lower end 14 to define a gas-filled cylindrical cavity 42 with seal 44 and a fluid chamber 46 with upper rod guide 40. The upper rod guide 40 can include one or more seals 50 and a cap 52. The cap 52 includes a magnetic portion or magnet 54. The fluid chamber 46 is divided into upper and lower chambers by a piston 56 that is slidably disposed for axial movement therein.

The axial movement of piston 56 pumps fluid between the chambers in fluid chamber 46 with orifices and valves providing damping in the conventional manner normal for shock absorbers. Since the sensor of this invention would normally be used with dampers having variable damping, one or more of the valves or orifices may be controllable in response to a control signal.

Damper piston 56 is attached to the lower end of rod 58, which extends upward through an opening 60 in rod guide 40 and sealed thereto by a standard sliding seal arrangement that retains the fluid in fluid chamber 46. Rod 58 extends upward and ends in a standard fitting 24 for attachment to the sprung mass or body of a motor vehicle at one comer thereof. A fitting 18 is attached to the lower end of reservoir tube 14 to provide attachment to a member of the unsprung mass or wheel assembly of the vehicle such as a control arm thereof.

A dust tube 20 includes a radial disc portion 22 attached to rod 58 at the end thereof adjacent fitting 24. A cylindrical portion 26 extends downwardly from disk portion 22, covering over a substantial length of the reservoir tube 12. Dust tube 20 can prevent dirt from entering and harming the seals. Rubber bag 28 can be a cylindrical sheath having one end 62 attached and sealed to a portion of the reservoir tube 12 adjacent the cap 52. The other end 63 of rubber bag 28 can be attached and sealed to a lower end of the dust tube 20 defining an air chamber 64 between the dust tube 20 and the reservoir tube 12. The air chamber 64 can be attached to a source of compressed air (not shown) by a fitting (not shown) for introducing or venting air from the air chamber 64, changing the overall length of the damper 10 and thus, the ride height of the vehicle. Relative movement of the sprung and unsprung masses of the vehicle can produce relative axial movement between reservoir tube 12, which is attached to and moves with the unsprung mass, and the assembly of rod 58, dust tube 20 and the piston 56, which is attached to and moves with the spring mass of the vehicle. Dust tube 20 can be made of a non-magnetic material such as plastic.

The linear sensor 72 includes a waveguide portion 70, which can be a sensor known as a magneto-restrictive, or magnetostrictive sensor, is positioned in the waveguide housing portion 34. It will be understood that the waveguide portion 70 can be considered the sensor, which typically has associated therewith electronic components that operatively permit the sensor to provide position data and so on. The electronics can be attached to the waveguide or located at a remote location. However, in regards to the present invention, it should be understood that the term sensor can refer to the waveguide sensor portion or a combination of elements including a waveguide sensor portion and an electronic portion. The waveguide portion 70 can be a rod-shaped member of the sensor 72 oriented in an axial direction with respect to the longitudinal axis of the damper 10. The waveguide portion 70 can be held in the dust tube housing portion 34 such that it is maintained a predetermined distance with respect to the magnet 54 on the cap 52. Due to the properties of the linear sensor, the predetermined distance may be as much as 13 millimeters. Thus the sensor 72 may be advantageously located in a protected housing 34 portion of the dust tube 20.

The electronic circuitry or elements (not shown) necessary for the operation of the sensor 72 can be located in the electronic housing portion 32 of the dust tube 20. The electronic housing portion 32 can be located at a portion of the dust tube 20 adjacent disc portion 22. A terminal portion 36, which contains electrical connecting leads and terminal elements (not shown) can be located adjacent the electronic housing portion 32 to allow connection thereto. A cap 37 can be connected to the terminal portion 36 to allow access to the housing, sensor, electrical components and so on.

In operation, a current pulse is generated in the sensor 72. The current pulse is directed through the waveguide portion 70. The pulse travels along the waveguide 70 until the pulse arrives at a portion of the waveguide that is positioned adjacent the magnet 54. The magnetic field of the magnet 54 has the effect of creating strain in the waveguide. The pulse is, at least in part, reflected by the strain in the waveguide 70. The sensor 72 measures the time elapsed between generating the pulse and receiving the reflection thereof. The sensor can calculate the distance the pulse traveled and thus, determine the position of the magnet. In addition, the position information, over time, can be used to calculate a velocity of the magnet, and thus, the relative changes in position and velocity between the vehicle body and respective wheel assemblies with a fast response time and high resolution. Thus, the damper 10 of the present invention can provide detailed information for a control system of a MR damper with no loss of accuracy of the measurements due to wear of the sensor elements.

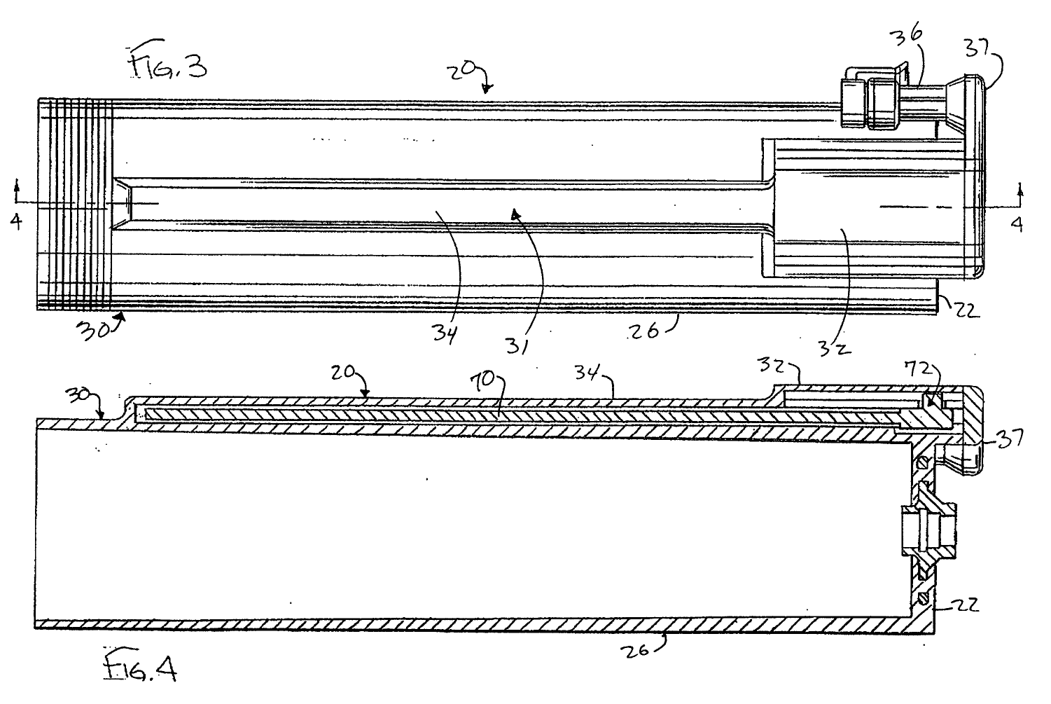

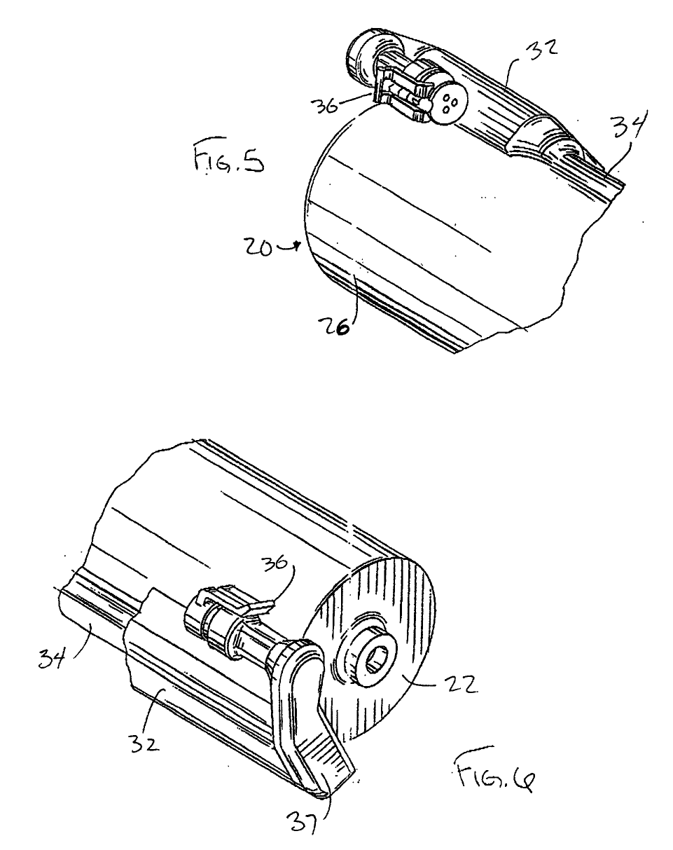

Referring to FIGS. 3-6, an embodiment of the dust tube 20 of the present invention is shown. The dust tube 20 can be made out of a non-magnetic material, which in a preferred embodiment, is formed of a thermoplastic material. Dust tube 20 can include disc portion 22 at an upper portion of the dust tube. A cylindrical sidewall portion 26 extends from the disc portion 22 to a bottom portion 30. The sidewall 26 includes a hollow electronics housing portion 32 located adjacent the side portion 22. The electronics housing 32 narrows to a longitudinal waveguide housing portion 34, which terminates adjacent the bottom end 30 of the dust tube 20. The electronics housing portion 32 is closed by cap 37 in which a terminal portion 36 is formed for allowing connection to an exterior electric connection (not shown) thereto. The sensor 72 can include a rod-shaped waveguide portion 70 inserted into the waveguide housing portion 34.

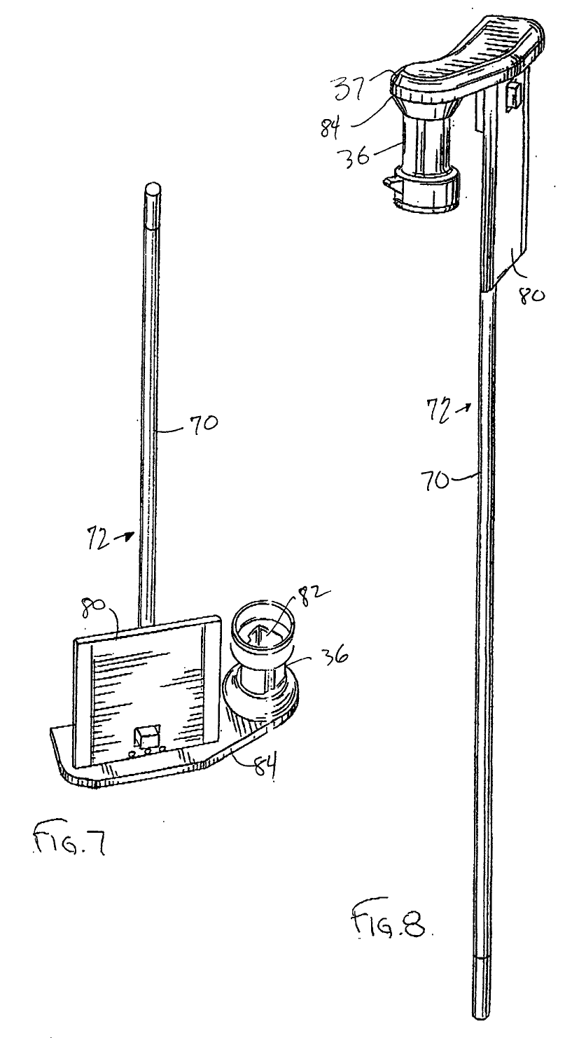

Referring to FIGS. 7 and 8, an embodiment of the linear sensor, which forms a portion of an embodiment of the present invention, is shown. In a preferred embodiment, the sensor 72 is a mangetostrictive linear sensor manufactured by NTS Instrumentation Corporation. The sensor 72 includes a rod-shaped waveguide portion 70. The waveguide portion 70 is connected to base portion 84 and is in electrical communication with electrical circuitry 80. A terminal portion 36 includes connection socket 82. Terminal portion 36 connects to base portion 84 adjacent the circuitry 80. Cap 37 covers the base portion 84 to seal internal wiring to the terminal portion 36 from contamination and provides access to the sensor 72.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A vehicle suspension damper configured to be arranged between a wheel assembly and a body of a vehicle comprising:
a cylindrical reservoir tube;
a piston mounted for reciprocating movement within the reservoir tube;
a piston rod connected to the piston and extending axially therefrom and through one end of the reservoir tube;
an annular rod guide assembly surrounding the piston rod and including a magnetic portion;
a non-magnetic dust tube disposed around the reservoir tube, the dust tube being operatively connected to the piston rod;
a generally longitudinal sensor housing formed in the dust tube adjacent the magnetic portion; and
a linear sensor disposed in the sensor housing adapted to detect the position of the magnetic portion.

2. The vehicle suspension damper of claim 1 wherein the sensor housing includes an electronics housing portion and a waveguide housing portion, the waveguide housing portion extending from the electronics housing portion.

3. The vehicle suspension damper of claim 2 wherein the linear sensor includes a waveguide portion disposed in the waveguide housing portion.

4. The vehicle suspension damper of claim 2 wherein the linear sensor includes an electronics portion operatively connected to the waveguide portion, the electronics portion being disposed in the electronics housing portion.

5. The vehicle suspension damper of claim 1 wherein the linear sensor includes a magneto-restrictive sensor.

6. The vehicle suspension damper of claim 1 wherein the dust tube is formed of a plastic material.

7. The vehicle suspension damper of claim 1 wherein the sensor includes a magnetostrictive waveguide portion.

8. The vehicle suspension damper of claim 7 wherein the waveguide portion is spaced apart from the magnetic portion a distance less than about 13 millimeters.

9. The vehicle suspension damper of claim 1 wherein the sensor is adapted to determine a relative velocity between the vehicle wheel assembly and body.

10. A dust tube for a vehicle damper comprising:
a non-magnetic cylindrical portion having a closed upper end;
a sensor housing formed in the cylindrical portion, the sensor housing including an electronics housing portion and a waveguide housing portion.

11. The dust tube of claim 10 wherein the electronics housing portion is formed adjacent the upper end of the cylindrical portion.

12. The dust tube of claim 11 wherein the waveguide housing extends from the electronics housing portion toward a lower end of the cylindrical portion.

13. The dust tube of claim 10 wherein the dust tube is made of a non-magnetic material.

14. The dust tube of claim 13 wherein the dust tube is made of a plastic material.

15. The dust tube of claim 10 further comprising:
a linear sensor disposed in the sensor housing adapted to detect the position of the magnetic portion.

16. The dust tube of claim 15 wherein the linear sensor includes a waveguide portion operatively connected to an electronic portion.

17. The dust tube of claim 16 wherein the waveguide portion is disposed in the waveguide housing portion.

18. The dust tube of claim 17 wherein the electronic portion is disposed in the electronic housing portion.

19. The dust tube of claim 15 wherein the linear sensor includes a magneto-restrictive sensor.

20. The dust tube of claim 16 wherein the linear sensor includes a magnetostrictive waveguide portion.

21. A suspension damper for a wheel assembly in a vehicle comprising:
means for housing a linear sensor in a dust tube of the damper;
means for magnetically creating a strain in the linear sensor positioned on a reservoir tube of the damper, wherein the dust tube and reservoir are adapted to reciprocate with respect to each other;
means for detecting the position of the strain in the linear sensor; and
means for calculating a relative position of the wheel assembly with respect to the vehicle based on the detected position of the strain.
